(19) United States
(12) Patent Application Publication
(10) Pub. No.: US 2009/0045251 A1
(43) Pub. Date: Feb. 19, 2009

(54) RESTRICTING BANK CARD ACCESS BASED UPON USE AUTHORIZATION DATA

(76) Inventors: Peeyush Jaiswal, Boca Raton, FL (US); Naveen Narayan, Flower Mound, TX (US)

Correspondence Address: HOFFMAN WARNICK LLC, 75 STATE ST, 14TH FLOOR, ALBANY, NY, 12207, US

(21) Appl. No.: 11/838,305

(22) Filed: Aug. 14, 2007

(51) Int. Cl. G06Q 40/00

(52) U.S. Cl. 235/379

(57) ABSTRACT

The present invention provides a system and method to detect credit card fraud. It allows the user, or the credit card company, to limit the use of a particular credit card according to authorized use data which is prespecified by the card holder, such as allowing authorized use within a geographical area or a set of ZIP codes. This way, the credit card owner, can limit the credit card's use according to the card holder, such as within a specified geographical area, a date frame, a time frame or even to within particular stores or with particular vendors. In addition, data from the credit card's magnetic stripe is conveyed and compared against the authorized use data. With respect to geographical information, the present use geographical data is provided either by the particular point-of-sale terminal or from a GPS system.

### FIELD OF THE INVENTION

The present invention relates generally to credit or bank card approval systems and, more specifically, to improvements to systems to examining a credit request based upon a credit card number and approving or disapproving based upon prespecified use authorization data, such as location data, of the requester.

### BACKGROUND OF THE INVENTION

Credit card fraud is a growing problem. Credit card fraud is a kind of fraud where a merchant (business, service provider, seller, etc.) is “tricked” into releasing merchandise or rendering services, believing that a credit card account will provide payment for goods/services. The merchant later learns that they will not be paid, or the payment they received will be reclaimed by the card's issuing bank. There are numerous types of credit card fraud: stolen card fraud (i.e., when a card holder loses or has their credit card stolen, it is possible for the thief to make unauthorized purchases on that card up until the card is cancelled), account takeover fraud (i.e., where fraud perpetrators call in and impersonate actual cardholders using stolen personal information), credit card mail order fraud (i.e., using a stolen credit card number, or computer generated card number, a thief will order stolen goods), skimming (i.e., “skimming” is the theft of credit card information by a dishonest employee of a legitimate merchant, manually copying down numbers, or using a magnetic stripe reader on a pocket-sized electronic device) and carding (“carding is a term used by fraudsters for a process they use to verify that sets of stolen credit card data are still valid).

It is an ongoing challenge to prevent or limit these types of credit card fraud. For instance, traditional fraud prevention, or screening, tools can only determine if a credit card is legitimate or if the user-entered account information matches those on record. Today, fraudsters can obtain personal credit card information, pose as the legitimate card holder, and bypass standard fraud checks. Another method of fraud prevention is that credit card companies apply a pre-set spending limit on credit card users. In general, the company is notified if either the user exceeds the credit limit or approaches very close to it or the spending pattern of the card's recent history does not match the usual spending pattern shown by the card's longer term history.

It could be that the primary credit card user wishes to restrict the use of the card—or secondary card—to certain geographical locations, times and days or even specific vendors. However, there presently is no means of setting such authorized use data and checking against the present requested use. In the case of geographical restrictions, there are no means of tracking usage by means of geographic location of the requested usage of the card by, for instance, ZIP codes or GPS coordinates.

When, for example, a credit card is stolen from an owner and taken to another location, such as another state, and used there. Even though the credit limit is not approached nor is the spending pattern changed, the credit fraud is successful. Therefore, another detection method is required.

Another example is where the secondary card belongs to a card holder's teenage child. The parent may wish to restrict amount of charges, and when and where the charges are being made.

In view of the foregoing, a need exists to overcome these problems by providing a system and method for detecting credit card fraud and only allowing authorized use.

### BRIEF SUMMARY OF THE INVENTION

The present invention provides a system and method to detect credit card fraud. It allows the user, or the credit card company, to limit the use of a particular credit card according to use authorization data which is prespecified by the card holder, such as allowing authorized use within a geographical area or a set of ZIP codes. This way, the credit card owner, can limit the credit card's use according to the card holder, such as within a specified geographical area, a date frame, a time frame or even to within particular stores or with particular vendors.

The credit card's magnetic strip is read by point-of-sale hardware which indicates to the credit card company (usually through a server) that a charge request is being made. It also indicates to the credit card company certain data, such as time and date as well as location of the charge request. Alternatively, a Global Positioning System (GPS) receiver may be used in the credit card to indicate to the credit card company the physical location of the credit card at the time of attempted use—as well as other data relative data (time, date, etc.). The credit card company, such as Master Card®, Visa® or American Express®, receives the charge request and then examines its records and accept or deny the charges being requested based upon the card holder's authorization data.

In order to indicate to the credit card company the card holder's allowed use choices, such as which geographical areas the user wishes his/her credit card to be authorized for use, the user would, for example, make selections with the credit card company, such as over the telephone or the Internet. For example, with respect to geographical preferences, a user would authorize his/her credit for use in his/her local home geographical area as well as locations which the user frequents for business and the like. If the user has children away for high school or college, those locations may be authorized as well. Further, authorization for use in locations can be changed on an as needed basis either by the user phoning the credit card company to make the change or by changing the authorization online through the user's portal with the various credit card companies. Other choices could be time of day, day of the week/month/year, as well as particular vendors.

For geographical preferences, a user will have to contact the credit card company and activate the card for a given set of zip codes. The card then will be usable only in those zip codes. The user may make changes to this list any time by calling the credit card company.

The magnetic strip/smart chip in the credit card is used with the card reader at the point-of-sale terminal to establish a connection with the credit agency for every transaction and validate the transaction using the card reader's current zip code and the user's list of valid zip codes or other data chosen. This provides for an additional line of defense against credit card/identity theft.

Another example is one in which the primary holder of a credit card has one or more secondary credit cards on the same account as the primary card holder (for use by a spouse or child for instance). The primary holder can be notified any time any of the secondary credit cards is used outside of the authorized use areas, such as a given time, date or a given geographical location (by means of ZIP codes or GPS coordinates). This allows the primary card holder to understand (and authorize if he/she chooses) the use of the secondary card holder(s). This may include authorization on a one-by-one basis should the primary card holder to so choose.

The illustrative aspects of the present invention are designed to solve one or more of the problems herein described and/or one or more other problems not discussed.

### BRIEF DESCRIPTION OF THE SEVERAL VIEWS OF THE DRAWINGS

These and other features of the invention will be more readily understood from the following detailed description of the various aspects of the invention taken in conjunction with the accompanying drawings that depict various embodiments of the invention, in which:

FIG. 1 is a diagram which illustrates the system and method of the present invention of a credit card user for authorizing his/her credit card company to allow charges against the user's card according to specific data—such as geographical areas.

FIG. 2 illustrates the process of the present invention in a flowchart form.

FIG. 3 illustrates the system and method showing a charge requestor using credit card requesting a charge from the credit card company server (authorization/validation engine).

FIG. 4 illustrates the system and method of the present invention showing the steps associated with a card holder setting up the authorized ZIP codes, the card holder making charge requests within and outside of the authorized ZIP codes, the system reaction, and the card holder modifying the authorized ZIP codes.

FIG. 5 illustrates the method of the present invention showing the steps for a charge requestor using a credit card requesting a charge from a credit card company server (authorization/validation engine).

The drawings are intended to depict only typical aspects of the invention, and therefore should not be considered as limiting the scope of the invention. In the drawings, like numbering represent like elements between the drawings.

### DETAILED DESCRIPTION OF THE INVENTION

The present invention provides a system and method to detect credit card fraud and to allow only authorized use. It allows the user, or the credit card company, to limit the use of a particular credit card to prespecified authorized use data, such as within a geographical area or a set of ZIP codes. This way, the credit card owner, can limit the credit card's use to a specified geographical area—possibly even during a specified timeframe or places (or gender of places).

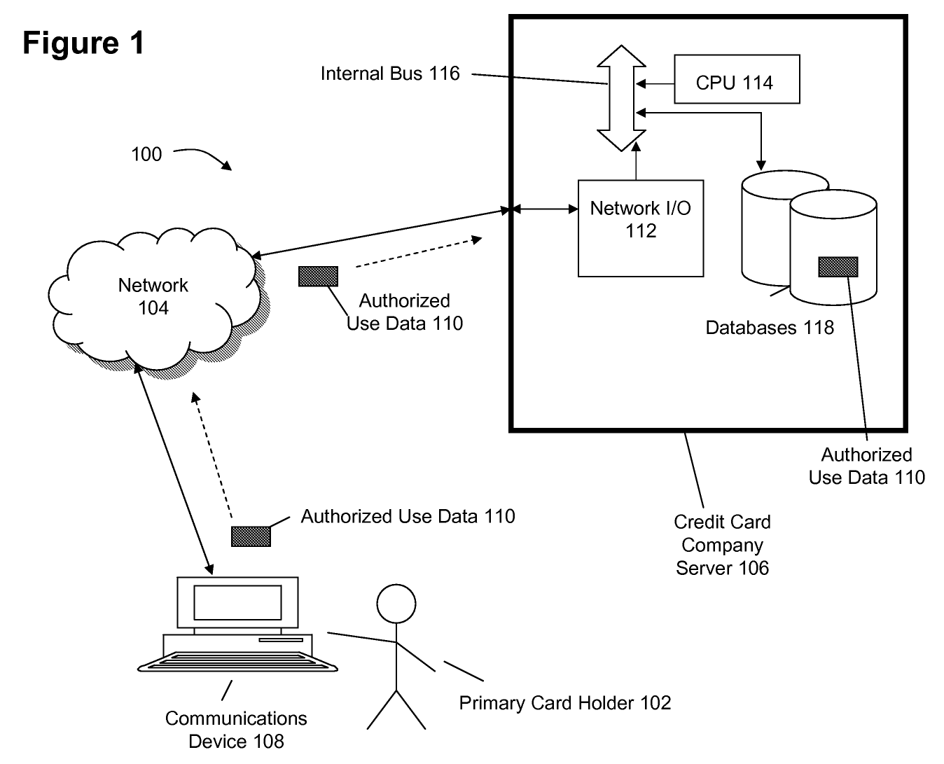

FIG. 1 is a diagram which illustrates the System/Process 100 of a credit card user for authorizing his/her credit card company to allow charges against the user's card according to specific data—such as geographical areas. Besides geographical area data, other data may include specific times of day, specific days of the year, specific stores and so forth. For instance, if the user, generally the primary card holder, wishes that his/her card be used only within a specific geographical area(s) or during certain days or times of days, etc., the user would authorize the credit card company to approve such charge requests according to that authorization data. While specific geographical areas are discussed throughout this specification, the other data mentioned above and others should be considered as well.

In System/Process 100, a Primary Card Holder 102 communicates the authorized use data (Authorized Use Data 110) through a Network 104 with Credit Card Company Server 106. This can and will be called the Authorization/Validation Engine as the Server is responsible for other tasks unassociated with the present invention. Primary Card Holder 102 utilizes Communications Device 108, such as a personal computer or telephone, to communicate with the Credit Card Company Server 106—although the user may contact directly with a representative with the Credit Card Company. Credit Card Company Server 106 comprises Network Input/Output (I/O) 112 for communicating with Network 104, using any of well-known network access, CPU 114, Databases 118 and Internal Bus 116.

Primary Card Holder 102 communicates Authorized Use Data 110 through Network 104 to Credit Card Company Server 106. It is received and appropriately stored in Databases 118.

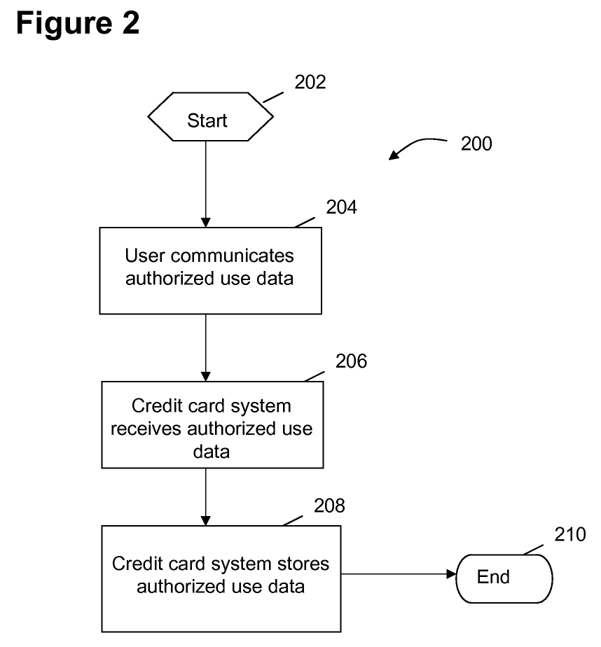

FIG. 2 illustrates this process 200 as well. The Process 200 begins at Start 202 and continues to Step 204 where User (Primary Card Holder 102 in FIG. 1) communicates the authorized use data, such as authorized geographical areas or other specifics as discussed above. At Step 206, Credit Card System (Credit Card Company Server 106 in FIG. 1) receives the authorized use data and, at 208, Credit Card System stores the authorized use data in its database.

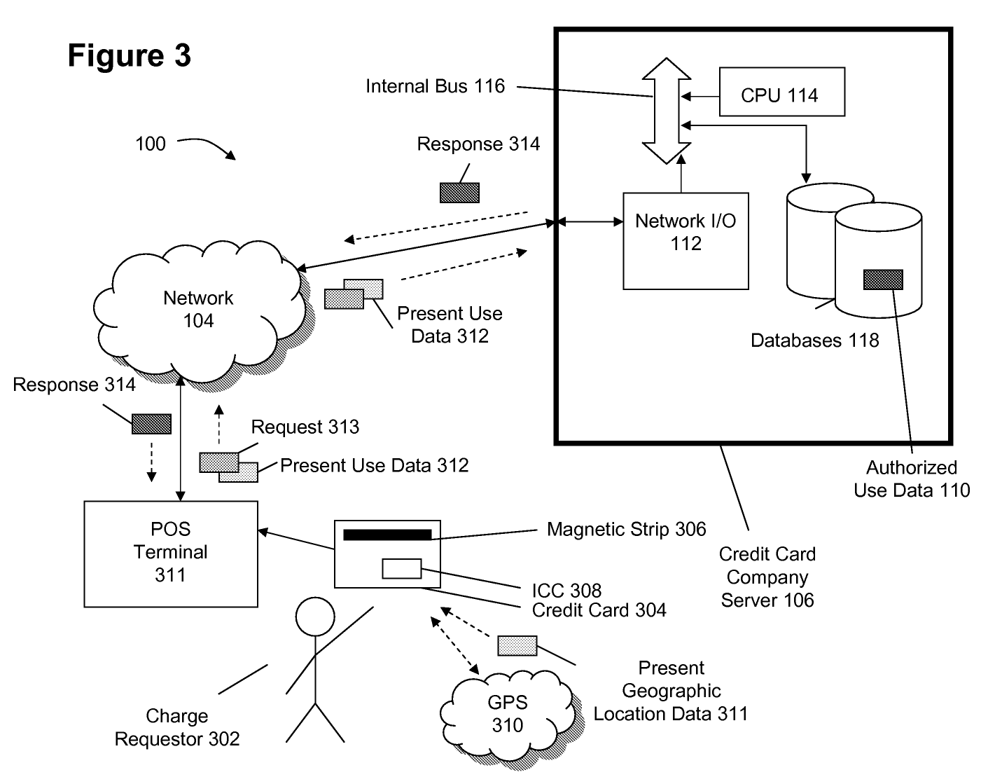

FIG. 3 illustrates the System/Process 300 showing a Charge Requestor 302 using Credit Card 304 requesting a charge from Credit Card Company Server 106. Credit Card 304 has the familiar Magnetic Strip 306 and, optionally, an Integrated Circuit Chip (ICC) 308, that is, it may be a “Smart Card”. Magnetic stripes, which provide the appropriate information to vendor, can typically be read by most point-of-sale hardware, such as Point of Sale (POS) Terminal 311, which are simply generic general-purpose computers that can be programmed to perform specific tasks. Smart cards are a newer generation of card containing an integrated circuit chip. The card may have metal contacts connecting the card physically to the reader, while contactless cards use a magnetic field or radio frequency (RFID) for proximity reading. The ICC 308 (such as a GPS receiver) may have the capability for communicating with a Global Positioning System (GPS) 310 for location identification purposes. GPS receivers come in a variety of formats, from devices integrated into cars, phones, and watches, to credit cards. In general, GPS receivers are composed of an antenna, tuned to the frequencies transmitted by the satellites, receiver-processors, and a highly-stable clock (often a crystal oscillator).

At POS Terminal 311, the Charge Requestor 302 makes a charge Request 313. The charge Request 313, along with the Present Use Data 312, such as the present geographical location data, is passed through the Network 104 to the Credit Card Company Server 106. In the case of geographical data, it could be retrieved from GPS 310 (using well-known triangulation techniques with the ICC 308) or directly from the point-of-sale terminal. Other present use data, such as time, day, vendor, etc., could be retrieved from the point-of-sale terminal. The Credit Card Company Server 106 receives the charge Request 313 and Present Use Data 312 and compares the charge Request 313 and Present Use Data 312 against the Authorized Use Data 110. This Authorized Use Data 110 has been retrieved from Database 118, of course, to run the comparison.

The Credit Card Company Server 106 processes the data and sends a Response 314, which would generally either be an “approval” or a “rejection” of the requested charge, but could include further information such as reason for rejection, time, date or store that the request would be approved, etc. Response 314 is routed through the Network 104 and passed back to the POS Terminal 311 to indicate to the vendor should accept the request for purchase.

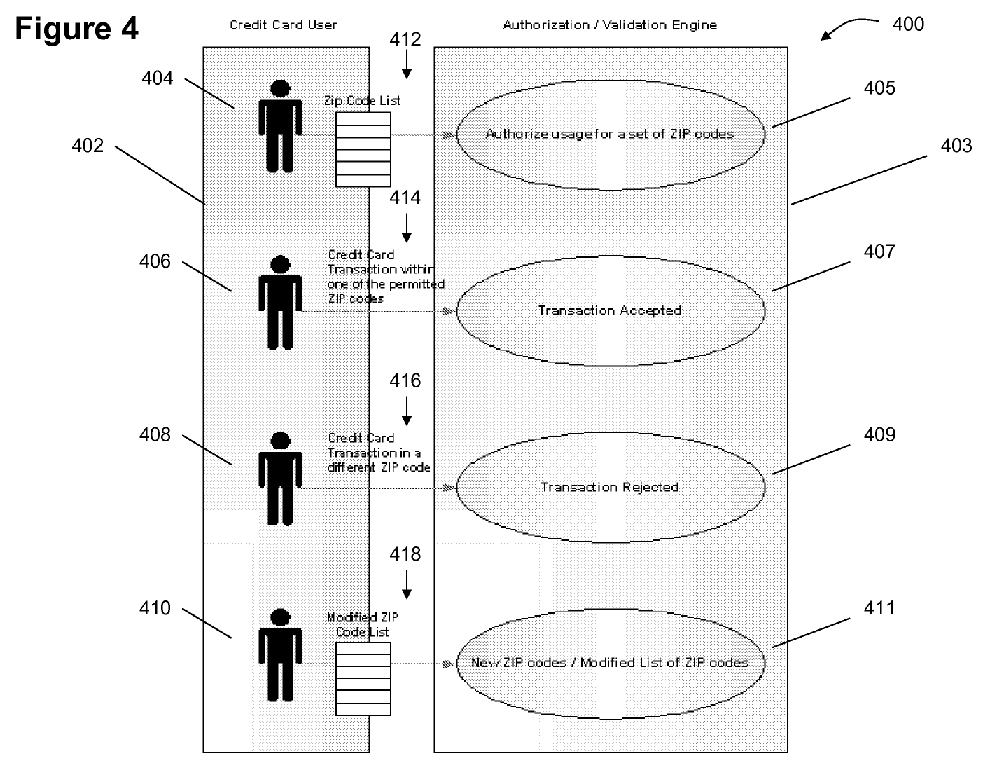

FIG. 4 illustrates the System and Method of the present invention 400 showing the steps associated with a card holder setting up the authorized ZIP codes, the card holder making charge requests within and outside of the authorized ZIP codes, the system reaction, and the card holder modifying the authorized ZIP codes. As was discussed above, besides ZIP codes, GPS coordinates can also be used to identify the authorized geographical locations (and location of the attempted credit card usage) should a Smart Card be used. Further, this same process applies to other authorized use data. As can be seen on the left hand side, the Credit Card User 402 is shown while, on the right hand side, the Credit Card Company Server or Authorization/Validation Engine 403 is shown. At 404, Credit Card Holder 402 communicates a list of ZIP codes at 412 to Authorization/Validation Engine 403 where the list of ZIP codes is noted as authorized geographical areas and stored. At 406, Credit Card Holder 402 (located in an authorized geographical area) requests a credit charge communicates at 414 to Authorization/Validation Engine 403 where the Authorization/Validation Engine 403 examines the request, identifies the geographical area from where the request was originated, determines that the original location is an authorized geographical location and approves the charge request. At 408, Credit Card Holder 402 (located outside of an authorized geographical area) requests a credit charge communicates at 416 to Authorization/Validation Engine 403 where the Authorization/Validation Engine 403 examines the request, identifies the geographical area from where the request was originated, determines that the original location is outside of an authorized geographical location and rejects the charge request. At 410, Credit Card Holder 402 communicates a modified list of ZIP codes at 418 to Authorization/Validation Engine 403 where the modified list of ZIP codes is noted as authorized geographical areas and stored.

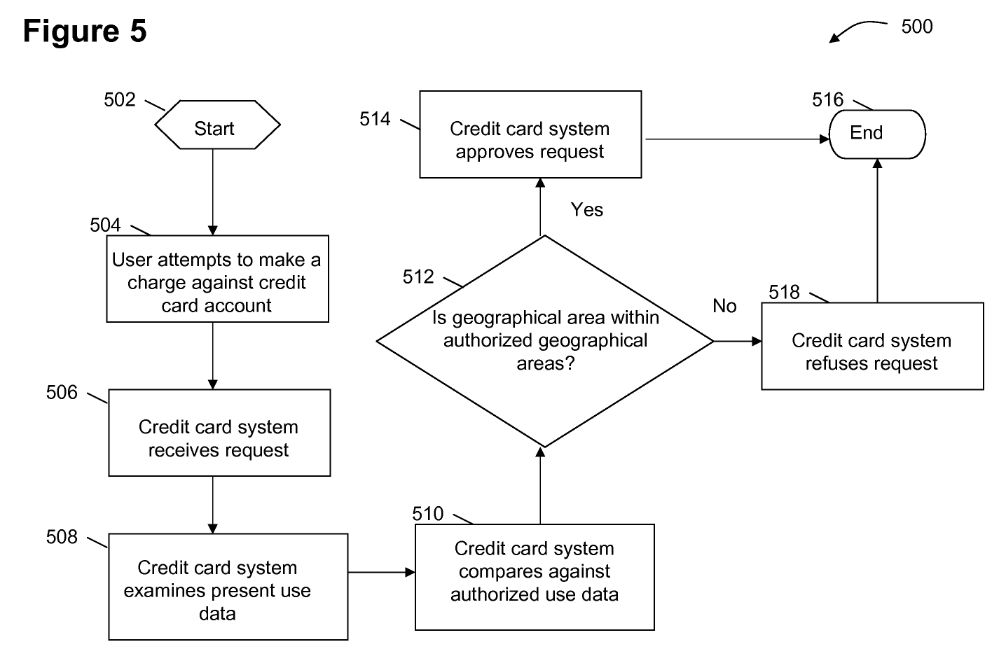

FIG. 5 illustrates the Process 500 of the present invention showing the steps for a Charge Requestor (302 FIG. 3) using Credit Card (304 FIG. 3) requesting a charge from Credit Card Company Server (106 FIG. 1). After Start 502, at Step 504, a Charge Requestor (User) makes a request for a charge approval. At 506, Credit Card Server receives the request. At 508, the Credit Card Server examines the data sent from the requesting origin (such as POS Terminal 311—FIG. 3). At 510, the Credit Card Server retrieves the data (Authorized Use Data 110—FIG. 1) and compares against the received data (Present Use Data 316—FIG. 3). At step 512, the system determines whether the request for use is within the authorized uses, such as from a geographical location (time/date/etc.) within the authorized geographical areas. At 514, if “Yes”, a response (Response 314—FIG. 3) indicating an approval is sent through the network to the requesting location and ends at 516. At 518, if “No”, a response indicating a rejection (along with other data as needed or desired) is sent through the network to the requesting location and ends at 516.

As can be seen from the foregoing, a need exists to overcome the problems of credit card fraud and the system and method of the present invention solves these problems.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method, in a credit card system, for receiving charge requests, each charge request having present use data, to make a charge against a credit card account, owned by an account owner, from a charge requester and for approving or rejecting the charge requests, the credit card system having the authorized use data received from the account owner, the method comprising the steps of:
receiving a charge request for a charge from a charge requestor;
determining whether the present use data is within the authorized use data for making charges against the credit card account; and
providing an approval or a rejection of the charge requests based upon whether the present use data is within the authorized use data.

2. The method according to claim 1 wherein the present use data includes the geographical data from where the charge request is originating and that the rejection or approval is determined based upon that factor.

3. The method according to claim 2 where the geographical data is provided by a point of sale terminal.

4. The method according to claim 2 where the geographical data is provided by a GPS system.

5. The method according to claim 1 wherein the present use data includes the data from whom the charge request is originating.

6. The method according to claim 1 wherein the present use data includes the data at which time and date the charge request is originating.

7. The method of claim 1 further including the step of receiving from the account owner a modification to the authorized use data and updating the authorized use data with the modification.

8. A computer program product in a computer readable medium for operating in a system comprising a network I/O, a CPU, and one or more databases, for implementing a method in a credit card system for receiving charge requests, each charge request having present use data, to make a charge against a credit card account, owned by an account owner, from a charge requestor and for approving or rejecting the charge requests, the credit card system having the authorized use data received from the account owner, the method comprising the steps of:
receiving a charge request for a charge from a charge requester;
determining whether the present use data is within the authorized use data for making charges against the credit card account; and
providing an approval or a rejection of the charge requests based upon whether the present use data is within the authorized use data.

9. The computer program product according to claim 8 wherein the present use data includes the geographical data from where the charge request is originating and that the rejection or approval is determined based upon that factor.

10. The computer program product according to claim 9 where the geographical data is provided by a point of sale terminal.

11. The computer program product according to claim 9 where the geographical data is provided by a GPS system.

12. The computer program product according to claim 8 wherein the present use data includes the data from whom the charge request is originating.

13. The computer program product according to claim 8 wherein the present use data includes the data at which time and date the charge request is originating.

14. The computer program product according to claim 8 further including the step of receiving from the account owner a modification to the authorized use data and updating the authorized use data with the modification.

15. A credit card system for receiving a request for approving a charge against one or more credit card accounts from a charge requestor and approving or rejecting the charge request, each charge request having present use data, based upon a comparison of the present use data against authorized use data, the authorized use data being previously provided by the credit card holder, comprising:
a network input/output device for receiving authorized use data from a credit card holder, for receiving charge requests from a charge requester, each charge request having present use data and for sending a response to the charge requestor based upon a comparison of the present use data and the authorized use data;
one or more databases for storing the authorized use data; and
an authentication engine for retrieving the present use data from the charge requests, retrieving the authorized use data, comparing the present use data against the authorized use data, providing an approval if the present use data confirms that the present use is consistent with the authorized use data, providing a rejection if the present use data confirms that the present use is inconsistent with the authorized use data, and utilizing the network input/output device to send the approval or rejection to the charge requestor.

16. The credit card system of claim 15 wherein the authorized use data includes data identifying geographical areas from which a charge request may be approved and further wherein the present use data includes data identifying the geographical areas from which charge requests are originated.

17. The credit card system of claim 16 wherein the data identifying geographical areas from which a charge request may be approved includes ZIP code data and further wherein the present use data includes data identifying the geographical areas from which charge requests are originated includes ZIP code data.

18. The credit card system of claim 16 wherein the data identifying geographical areas from which a charge request may be approved includes GPS location data and further wherein the present use data includes data identifying the geographical areas from which charge requests are originated includes GPS location data.

19. The credit card system of claim 15 wherein the authorized use data includes data identifying times and days at which a charge request may be approved and further wherein the present use data includes data identifying times and days at which charge requests are originated.

20. The credit card system of claim 15 wherein the authorized use data includes data identifying the vendor from which a charge request may be approved and further wherein the present use data includes data identifying the vendor from which charge requests are originated.

21. The credit card system of claim 15 wherein the authentication engine receives from the account owner a modification to the authorized use data and updating the authorized use data with the modification.
